(19) United States
(12) Patent Application Publication
(10) Pub. No.: US 2003/0007131 A1
(43) Pub. Date: Jan. 9, 2003

(54) Overhead projector lens arms

(76) Inventor: David Mitchell, Omaha, NE (US)

Correspondence Address: DAVID E. MITCHELL SR., 2518 MAPLE ST., OMAHA, NE, 68111, US

(21) Appl. No.: 10/079,146

(22) Filed: Feb. 19, 2002

Related U.S. Application Data
(60) Provisional application No. 60/270,000, filed on Feb. 20, 2001.

(51) Int. Cl. G03B 21/14

(52) U.S. Cl. 353/22

(57) ABSTRACT

A projector lens that projects a 13 inch television or a 15 inch computer monitor to a 60 inch or 80 inch screen it is projected from an enclosed box that at the end of the enclosed box there is a open center square from which the projector len projects from please note from the weak lumens the television and monitor must be set at its highest brightness level and adjusted colors.

### BACKGROUND OF THE INVENTION

1. Field of the Invention

The invention relates to overhead projectors.

2. Description of the Prior Art

The invention relates to a projector lens normally used for an overhead projector. It projects visual displays and transparent images. The prior art shows the enclosed box that demonstrates it's construction.

The enclosed box basically used with the projector lens will project the television or computer monitor the same as it would for visual displays. It widens the screen to maximum dimensions to whatever it was adjusted to

### DETAIL DESCRIPTION OF THE INVENTION

Referring to the drawing in FIG. 1, the enclosed projector box includes an overhead projector lens 2, a 6 in by 6 in cut out center end square for reflecting to the projector lens To project the images for display 27, a top cover with the 6 in by 6 in cut out center end square 67, a full construction of the enclosed box 10, a full construction of the small box 12, FIG. 2 shows the parts of assembly left side of the enclosed box 37, right side of the enclosed box 32, front end of the enclosed box 42, back end of the enclosed box 47, bottom of the enclosed box 77, top of the enclosed box with a 6 in by 6 in center square cut out 67, left side of small box 7, right side of small box 33, front end of small box 36, back end of small box 72, top of small box 76, overhead projector lens 2.

### BRIEF DESCRIPTION OF THE DRAWINGS

A enclosed projector box according to the invention will now be described by the way of example with reference to the accompanying drawing in which:

FIG. 1 is a completed view of the enclosed projector box; and

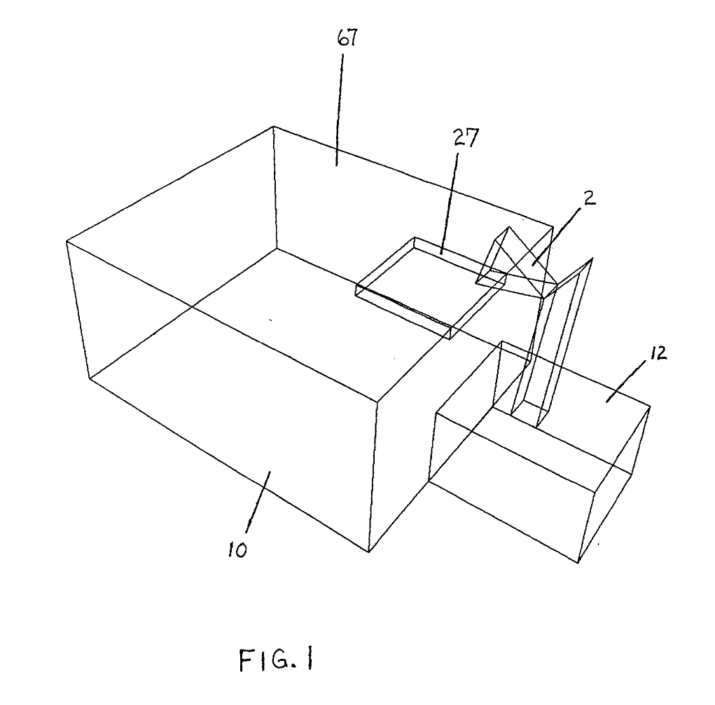

FIG. 2 is a schematic view of assembly of pieces.

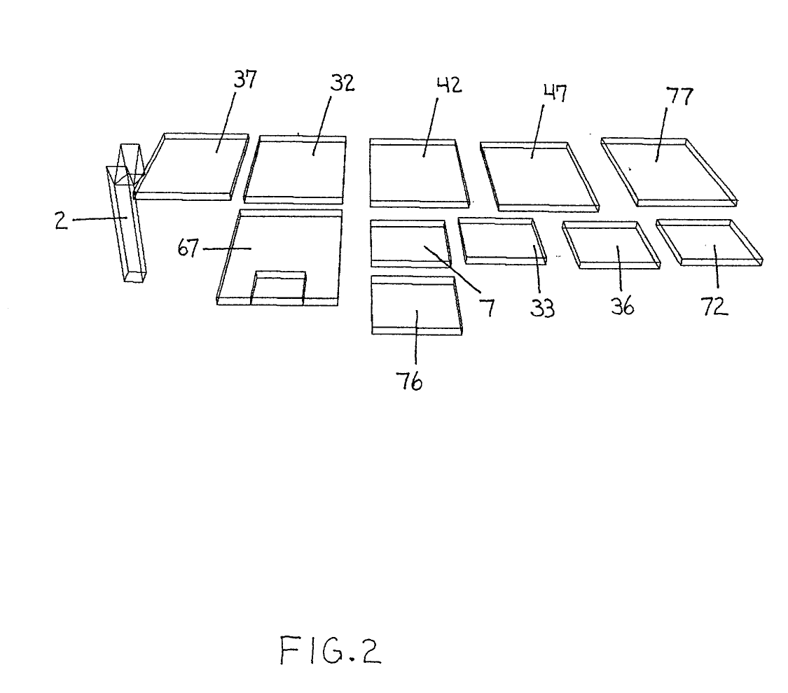

### SUMMARY OF THE INVENTION

It is an object of the invention to overcome the size of the dimension of a television or computer monitor screen. The invention is to project a larger picture screen for a 13 inch television or computer monitor. It is used for visual or computer displays, videos, and basic television viewing.

I claim:

1. A projector lens enclosed box for weak lumens as in televisions or computer monitors. For projection visual displays as in expanding screen width and dimensions. I am claiming combining of the two, the projector lens and the enclosed box for magnifying of lumens that comes from the enclosed box therefore, the enclosed box could be increase or decrease in size for larger or smaller television and monitors. So the claim is for the combination of the two, the projector lens and the enclosed box.
